(19) United States
(12) Patent Application Publication
(10) Pub. No.: US 2018/0302019 A1
(43) Pub. Date: Oct. 18, 2018

(54) SERIES-PARALLEL ELECTRIC VEHICLE DRIVE SYSTEM

(71) Applicant: Ford Global Technologies, LLC, Dearborn, MI (US)

(72) Inventors: Shuitao Yang, Canton, MI (US); Lihua Chen, Farmington Hills, MI (US); Yan Zhou, Canton, MI (US); Mohammed Khorshed Alam, Canton, MI (US); Fan Xu, Novi, MI (US); Baoming Ge, Okemos, MI (US)

(21) Appl. No.: 15/490,134

(22) Filed: Apr. 18, 2017

(51) Int. Cl. H02P 27/08; H02P 6/08; H02M 7/537; H02M 1/12; B60L 15/20; B60L 11/18

(52) U.S. Cl. CPC H02P 27/08; H02P 6/08; H02M 7/537; H02M 1/12; B60L 2210/44; B60L 11/1803; B60Y 2200/91; B60L 2220/12; B60L 2220/14; B60L 15/20

(57) ABSTRACT

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a series-parallel electric vehicle drive system, including a controller commutatively coupled to at least one inverter circuit with a serial insulated gate bipolar transistor (IGBT) and a parallel IGBT. The system includes a dc power source connected to an inverter circuit and a winding of a motor connected to an output of the invert circuit, wherein the inverter circuit generates a motor control signal.

### BACKGROUND

An Electric Vehicle (EV) uses one or more electric motors or traction motors for its mean of propulsion. An EV's propulsion system can use various regulators and inverters to regulate and transform a direct current (DC) from a battery to an alternating current (AC) required by the EV's induction motor. The speed of the electric motors or traction motors can be regulated by controlling the frequency and phase of the inverter.

However, electric motors in EVs can draw as much as 1,000 amps requiring expensive discrete components to achieve the regulation and inversion. These expensive discrete components require complex heatsinks to dissipate the heat they produce when switching the DC to the pulse width modulated (PWM) voltage. Various circuits and control strategies have been developed in order to address the cost and heat issues, but these prior approaches are often complex and difficult to implement. Therefore, improved circuits and methods to improve an EV drive efficiency and operation are needed.

### BRIEF DESCRIPTION OF THE DRAWINGS

FIG. 1 shows a schematic of a typical electric vehicle (EV) drive system.

FIG. 2 illustrates a series-parallel electric drive system for an EV.

FIG. 3 is an exemplary plot of four carrier waveforms used to modulate four inverters.

FIG. 4A is an exemplary plot of three phase currents in a first inverter.

FIG. 4B is an exemplary plot of three phase currents in a second inverter.

FIG. 4C is an exemplary plot of three phase currents in a third inverter.

FIG. 4D is an exemplary plot of three phase currents in a fourth inverter.

FIG. 5 is an exemplary plot of three modulation signal for one of the four inverters.

FIG. 6 is an exemplary plot of the DC bus current when using four inverters.

### DETAILED DESCRIPTION

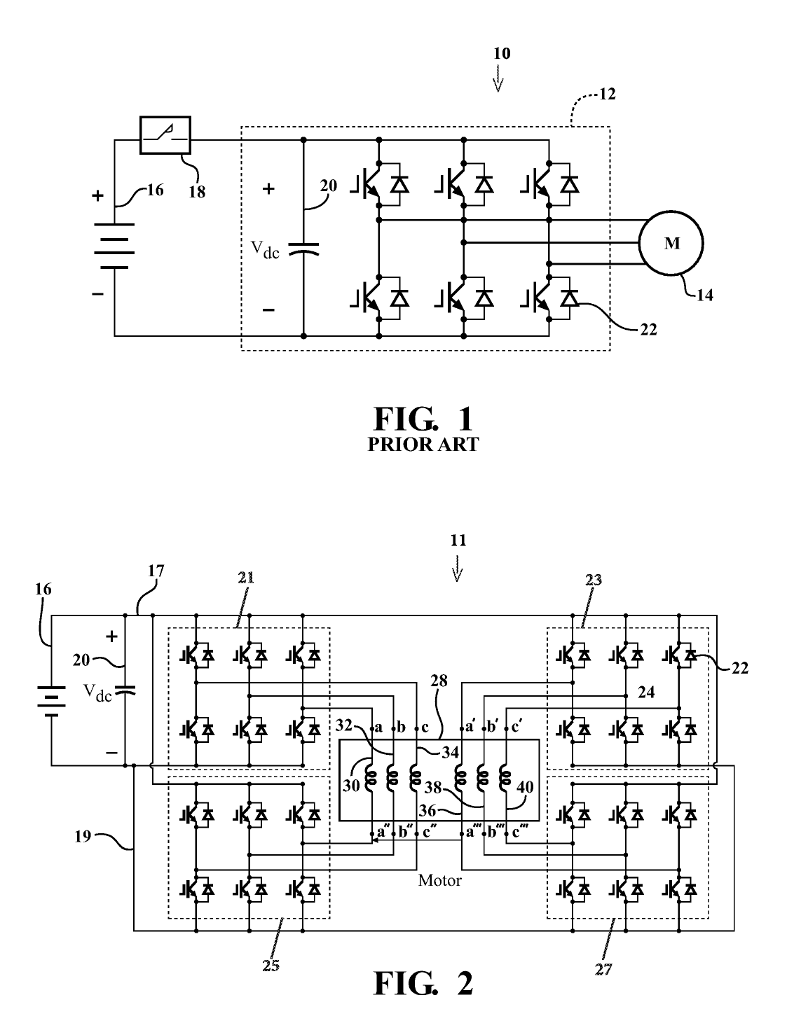

With reference to the Figures, wherein like numerals indicate like parts throughout the several views, FIG. 1 shows a typical electric vehicle (EV) drive system 10. An EV power source 16, for example, a high voltage battery is communicatively coupled to a battery contactor switch 18, which is communicatively coupled to an input of an inverter system controller (ISC) 12. The output of the ISC 12 is then communicatively coupled to a motor 14. The motor 14 can be an inductor motor (IM) or a synchronous motor (SM). The DC power source 16 can a battery pack, a super capacitor, a kinetic energy device or an on-board generating device.

An inductor motor is an AC electric motor in which an electric current in the motor's rotor needed to produce torque is obtained by electromagnetic induction from the magnetic field of the stator winding. Therefore, an induction motor can be made without electrical connections to the rotor. An induction motor's rotor can be either a wound type or a squirrel-cage type.

A synchronous motor is an AC motor in which, at steady state, the rotation of the shaft is synchronized with the frequency of the supply current. In other words, the rotation period is exactly equal to an integral number of AC cycles. Synchronous motors contain multiphase AC electromagnets on the stator of the motor that create a magnetic field which rotates in time with the oscillations of the line current. The rotor with permanent magnets or electromagnets turn in step with a stator field at the same rate, and as a result provides the second synchronized rotating magnet field of the AC motor.

In a merging onto a highway scenario, the EV requires obtaining a maximum amount of torque from the electric drive system in the quickest possible time. With a high performance electric vehicle, it is not unforeseeable for the electric drive system to draw as much as 1000 amperes from the HV battery.

One technique to deliver high currents to the motors from the ISC is to connect multiple power devices of the ISC in parallel. One example of the aforementioned power device is an insulated-gate bipolar transistor (IGBT) 22 as shown in FIG. 1. In addition to the IGBT, the power device can be a power bipolar transistor (not shown) or a power MOSFET transistor (not shown). Thus by deploying power devices in parallel, it is possible to output high current with lower current rated devices, and therefor avoid the high costs of using high current power devices.

In one such configuration, an ISC may use four power devices in parallel for each of the three phases of voltages and their associated currents fed to the motor to achieve the high current capability of the high current power device. In this configuration, each power device only needs to carry ¼ of the total current. Deploying power devices in parallel permits, by adding-on an additional power devices in parallel will achieve an even a higher maximum current. For example, three power devices with a current rating of 100 amps each can be combined in parallel to produce a total rating of 300 amps. Four power devices with a current rating of 100 amps each can be combined in parallel to produce a total rating of 400 amps.

The designer of an ISC can use lower current, less expensive power devices, obtain the power devices in larger quantities, and thus receive a discount on the cost of the part form the manufacture of the power device. However, a problem for utilizing power devices in parallel is the current sharing between the paralleled power devices. Any current unbalance will cause the power devices to become inefficient, and therefore decrease the power device's output current capability.

To reduce the number of paralleled power devices, the number of the motor's parallel windings can be increased. An example being, to twelve windings with four ISCs that eliminate having to have the power devices in parallel, but rather create a series configuration. As a result, the current sharing problem is eliminated. However, this solution will make designing and implementation of motor design and motor control extremely difficult and will require more current sensors. In other words, the twelve windings will require twelve current sensors increasing the costs and complexity of the system.

FIG. 2 shows a series-parallel electric drive system 11 based upon a series parallel inverter connected to an open winding configuration to an EV motor 28. The EV motor 28 can be either a synchronous motor or an inductor motor. The motor 28 has a six winding array. A first set of the six winding array has windings 30 32 34 and a second set of the six winding array has windings 36 38 40. The windings are communicatively coupled to a set of four inverter circuit 21 23 25 27, and each of the inverter circuit 21 23 25 27 may share a DC power source 16 without the need of additional power devices. As a result, there is no current sharing or current unbalancing issues. Additionally, this configuration also permits each inverter 21 23 25 27 to have its own or shared DC power source 16. Each inverter 21 23 25 27 comprises a serial insulated gate bipolar transistor (IGBT) and a parallel insulated gate bipolar transistor. Alternatively, the IGBT can be any semiconductor power device. One example is a power bipolar transistor or a power MOSFET transistor.

An advantage this embodiment this embodiment has over other inverter circuits that a filter capacitor 20 which may be placed across the DC power source 16 to reduce any ripple currents can have smaller capacitance value, thus reducing the size and the cost of the capacitor 20.

The four inverter circuit 21 23 25 27 are controlled by a controller unit (not shown) or a motor control unit (not shown) to determine such parameters as an inverter frequency value and an inverter frequency phase value which the inverter 21 23 25 27 outputs to the motor as a motor control signal. In some embodiments, the controller unit and the motor control unit can be combined into a single unit. The inverter 21 23 25 27 are made up of a series and parallel IGBT 22. The motor control signal may be for example, a pulse width modulated (PWM) signal applied to the IBGTs of the inverter 21 23 25 27. As a result, the inverter outputs a winding control signal to the motor windings to produce a motor speed and a motor torque of the EV motor 28.

The ISC controller can be communicatively coupled to a controller area network (CAN) bus (not shown), e.g., in a known arrangement to a plurality of electronic control units (ECUs) (not shown), as is known. An ISC controller, such as for systems or controllers mentioned above, typically contains a processor and a memory, each memory storing instructions executable by the respective processor of the controller. Each controller memory may also store various data, e.g., data collected from other controllers or sensors in the EV, such as may be available over the CAN bus, parameters for operations of the controller, etc.

The present embodiment permits the ISC controller to control the phase shift between any two separate windings. The phase shift can be any value from zero to +/−180 degrees. Since the ISC controller has independent control of the four inverter circuit 21 23 25 27, allows the system 11 to be optimized. An example being inverter 21, inverter 23, inverter 25 and inverter 27 may be set to have different phase shift for their PWM motor control signals in order to reduce the capacitor ripple current, which as discussed above reduces the capacitor 20 size and cost.

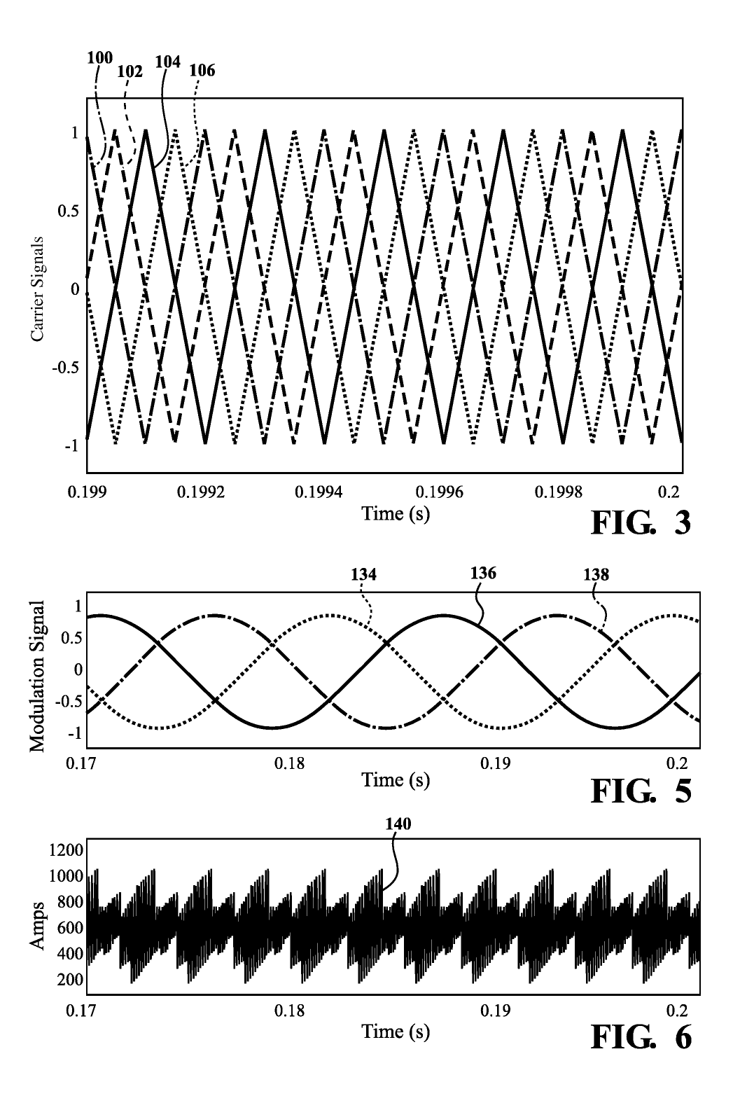

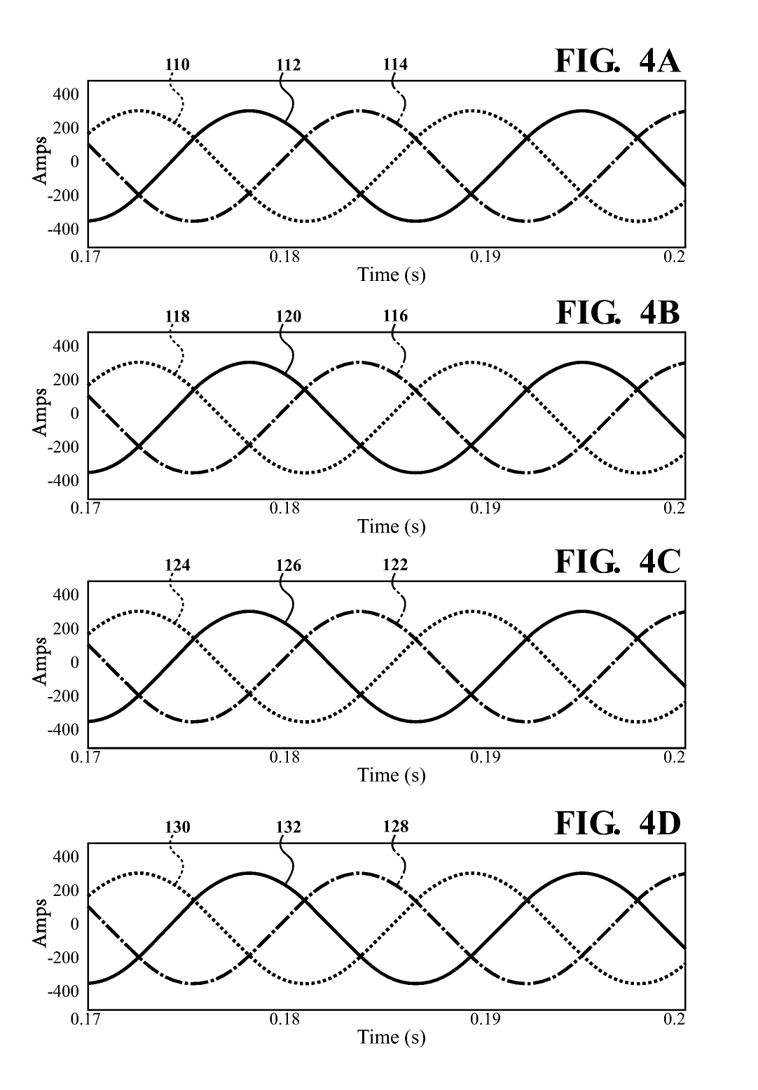

FIG. 3 is an exemplary plot of four carrier waveforms 100 102 104 106 generated by the ISC controller used to modulate the four inverter circuit 21 23 25 27. The four inverter circuit 21 23 25 27 each have a set of three-phase currents. FIG. 4A shows three phase current 110 112 114 of the inverter 21. FIG. 4B shows three phase current 118 120 122 of the inverter 23. FIG. 4C shows three phase current 124 126 128 of the inverter 25. FIG. 4D shows three phase current 130 132 134 of the inverter 27.

FIG. 5 is an exemplary plot of the motor control signal as a set of three-phase modulation signal 134 136 138. The y axis represents the amplitude of the modulation signals in unit form (−1 though +1) plotted against time on the x-axis. The three-phase modulating signals 134 136 138 are compared to the motor control signal from each inverter and the ISC controller adjusts the frequency and amplitude of the three-phase modulating signals 134 136 138 for peak performance while minimizing ripple. As a result, the DC bus current 19 is shown in FIG. 6.

For example, if the DC bus voltage from the DC power source 16 is 375 V with a power factor of 0.75, a modulation index is 0.86, and a total load current is 900 Amps rms. The resultant DC bus ripple current rms value is 172 Amps. A ripple ratio is the DC bus ripple current rms value divided by the total load current or 172 Amps/900 Amps=0.19. For comparison, if a single inverter is employed to achieve the same current of 900 Amps with the same power factor, modulation index, the DC bus ripple current rms will be 495 Amps, so the ripple ratio is 495 Amps/900 Amps=0.55. The single inverter would require a larger more expensive high voltage DC capacitor to handle the high ripple current.

As used herein, the adverb “substantially” modifying an adjective means that a shape, structure, measurement, value, calculation, etc. may deviate from an exact described geometry, distance, measurement, value, calculation, etc., because of imperfections in the materials, machining, manufacturing, sensor measurements, computations, processing time, communications time, etc.

Computing devices such as those discussed herein generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java′, C, C++, C#, Visual Basic, Python, Java Script, Perl, HTML, PHP, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A series-parallel electric vehicle (EV) drive system, comprising:
a controller unit commutatively coupled to an input of a motor control unit to send a control signal to said motor control unit, said motor control unit contains at least one inverter circuit, and said at least one inverter circuit further comprises a serial insulated gate bipolar transistor (IGBT) and a parallel IGBT;
an EV power source connected to said motor control unit to produce a winding control signal from said control signal and from said EV power source; and
a winding of a traction motor, said winding communicatively coupled to an output of the motor control unit to receive the winding control signal to regulate said traction motor.

2. The system of claim 1, wherein the motor control unit has four of said inverter circuits.

3. The system of claim 1, wherein the traction motor includes a six winding array, wherein each winding of said six winding array is connected to the motor control unit.

4. The system of claim 1, wherein a filter capacitor is further connected to the EV power source to reduce ripple current.

5. The system of claim 1, wherein the controller unit is incorporated into the motor control unit.

6. The system of claim 1, wherein the control unit controls an inverter frequency of the winding control signal for the inverter circuit.

7. The system of claim 1, wherein the control unit controls a phase shift of the winding control signal for the inverter circuit.

8. The system of claim 1, wherein the EV power source can be at least one of a battery pack, a super capacitor, a kinetic energy device and an on-board generating device.

9. A series-parallel electric vehicle (EV) system to control an electric vehicle (EV) motor, comprising:
an EV power source coupled to a motor control unit;
an inverter circuit located in said motor control unit, wherein said inverter circuit comprises a serial insulated gate bipolar transistor (IGBT) and a parallel IGBT; and
a controller communicatively coupled to the inverter circuit, wherein the controller sends a control signal to the inverter circuit to output a winding control signal to a motor winding of a traction motor.

10. The system of claim 9, wherein the motor control unit has four of said inverter circuits.

11. The system of claim 9, wherein the traction motor includes a six winding array, wherein each winding of said six winding array is connected to the motor control unit.

12. The system of claim 9, wherein the system has a filter capacitor coupled to the EV power source and the inverter circuit to reduce ripple current.

13. The system of claim 9, wherein the controller unit is incorporated into the motor control unit.

14. The system of claim 13, wherein the control unit controls an inverter frequency of the winding control signal for the inverter circuit.

15. The system of claim 14, wherein the control unit controls a phase shift of the winding control signal for the inverter circuit.

16. The system of claim 9, wherein the EV power source can be at least one of a battery pack, a super capacitor, a kinetic energy device and an on-board generating device.

17. A method for controlling a traction motor with a series parallel inverter in an electric vehicle (EV), comprising:
sending a motor control signal to control a motor speed and a motor torque to an inverter circuit in a motor control unit connected to a EV power source, wherein the inverter circuit contains at least one of a serial insulated gate bipolar transistor (IGBT) and at least one parallel IGBT, wherein the motor control signal contains an inverter frequency value; and
sending a winding control signal to a winding of said traction motor.

18. The method of claim 17, wherein the traction motor includes a six winding array, wherein each winding of said six winding array is connected to the motor control unit.

19. The method of claim 18, further comprising generating an inverter frequency of the winding control signal for the inverter circuit.

20. The method of claim 18, further comprising generating a phase shift of the winding control signal for the inverter circuit.
